(19) United States
(12) Patent Application Publication
(10) Pub. No.: US 2007/0154687 A1
(43) Pub. Date: Jul. 5, 2007

(54) Item bearing a printed image

(76) Inventors: Markus Luthi, Marthalen (CH); Matthias Reinhold, Neuhausen (CH)

Correspondence Address: FISHER, CHRISTEN & SABOL, 1725 K STREET, N.W., SUITE 1108, WASHINGTON, DC, 20006, US

(21) Appl. No.: 11/583,912

(22) Filed: Oct. 20, 2006

(30) Foreign Application Priority Data
Oct. 26, 2005 (EP) 05 405 605.6

(51) Int. Cl. B41M 5/00

(52) U.S. Cl. 428/195.1

(57) ABSTRACT

An item bearing an image printed with at least one ink that is fluorescent under ultra-violet radiation of specific wavelength is such that the image comprises two partial images, whereby a first partial image in a red fluorescent ink and the second partial image in a green or blue fluorescent ink are arranged as negative images with respect to each other in such a manner that to an observer simultaneously viewing both partial images, each eye individually through a colour filter that is selected for each of the fluorescent colours of both partial images, the partial images appear as a three-dimensional image. A preferred application for the item is for packaging, packing materials, packing aids, bonds or entry tickets with counterfeit-proof and/or optically demanding surface area.

The invention relates to an item bearing a printed image comprising at least one colored printing material that is fluorescent under ultra-violet radiation.

Counterfeit-proof packaging is of great importance in particular for the pharmaceutical industry. Basically, however, also in other areas there is a desire for counterfeit-proof packaging or products, in particular in the consumer industry, e.g. in the packaging of foodstuffs, cosmetic articles, clothes, software and music CD's or bonds. An item with counterfeit-proof packaging may be a form of packaging, packing, an aid to packing or a product itself on which a surface area is designed in the form of a safety feature, e.g. a label with an optical effect.

Counterfeit-proof packaging or packaging aids can serve as a guarantee of origin which allows the customer to recognise that the purchased product really has been produced and packaged by the desired producer. Counterfeit-proof packaging may also be used as a guarantee of first opening e.g. in the form of a label, revenue stamp or seating strip etc., which has e.g. been fixed over a closure on a wide-necked glass, over a seam between a lid and a container or over the tear-open closure on a pouch. On opening the packaging in question the label, revenue stamp or sealing strip is destroyed thus indicating that first opening has already taken place. It is also possible to place or enclose an item in a form of outer packaging whereby the outer packaging exhibits characteristic features that are unmistakeable and cannot be copied, and show that the contents have been packaged by a particular supplier.

Known counterfeit-proof forms of packaging and products are provided with holograms on their surface or exhibit colour-coding or invisible features. In practice holograms, for example, have proved to achieve a high degree of proof against counterfeiting. Examples are hologram labels or lid films with integrated holograms. Producing individualised holograms, however, involves enormous expense.

Known from the article by David Tidmash “Simply (But Not So Simple) Inks!” in AUTHENTICATION NEWS, May 2005, Vol.11 is the use of images—printed using the three primary colours (red, green and blue) which are fluorescent under UV radiation—as colourless print in visible light on security films and laminates for passports and identity cards as a means of increasing the degree of proof against counterfeit.

The object of the invention is achieved by way of providing an item of the kind mentioned at the start with printing which is visible under UV radiation, details of which are not easily recognisble to an observer and therefore provide a further increase in the degree of proof against counterfeit.

A first solution according to the invention is such that the image is made up of two partial images, whereby a first partial image in a red fluorescent ink and the second partial image in a green or blue fluorescent ink are arranged as negative images with respect to each other in such a manner that to an observer simultaneously viewing both partial images, each eye individually through a colour filter that is selected for each of the fluorescent colours of both partial images, the partial images appear as a three-dimensional image.

The first solution according to the invention makes use of the known phenomenon in the visible light range known as an analglyphic process. This method is employed e.g in books for teaching mathematics to illustrate stereometry or spherical trigonometry.

The essence of this invention lies in the application of the analglyphic process from the visible light range to the UV range, whereby the following important, special aspect must be taken into account.

In the case of images which are printed in inks that are recognisible in visible light, there is the convention to use a red filter for the left eye. The left eye then only sees the corresponding partial image which is printed in green or blue. A green or blue filter is used for the right eye. The right eye then sees only the corresponding partial image which is printed in red.

In the case of fluorescent colours the partial images must be negatively printed. Further, for the left red filter there has to be a corresponding partial image with red fluorescence, for the right green or blue filter there must be a corresponding partial image with green or blue fluorescence.

The UV radiation normally used in connection with fluorescent effects has a wave length of 365 nm and lying in the long wave range is also known as black light.

A second solution to the objective according to the invention is such that that the image made up of a first partial image which is an essentially non-correlating interference pattern in a red fluorescent printing ink and a second partial image forming an essentially correlating pattern containing information which is printed with a green or blue fluorescent ink, whereby the pattern in the second partial image containing information is not recognisible for an observer viewing the partial images through a colour filter selected for the red fluorescent printing ink.

The second solution according to the invention also makes use of a known phenomenon in the visible light range, whereby a pattern containing information is printed in a very light green or blue (cyanogen). When viewed through the red filter, the green or blue still produces a strongly contrasting black/white image. If the interference pattern is printed in a strong red colour, the green or blue pattern practically disappears for the observer or at least appears as a non-correlating pattern.

Preferably, the fluorescent first partial image is printed using a strong red ink and the second partial image using green or blue ink.

Proof against counterfeit can be increased further by the appropriate choice printing ink in that one of the two fluorescent inks is activated by UV radiation both in the long wave (365 nm) and in the short wave (254 nm) ranges and the other fluorescent ink is activated only in the short wave range. This way only a partial image is seen in the normal long wave range and a forger may be satisfied with that. Only when viewed in the short wave range do both partial images become apparent and can, in keeping with the first solution according to the invention, then be seen as an analglyphic or three dimensional image. In the case of the second solution according to the invention the coulous for printing are chosen such that the green or blue fluorescent ink for the second partial image with the pattern containing information is activated only in the short wave range (254 nm) and the red fluorescent ink for the first partial image with the interference pattern is activated both in the long wave range (365 nm) and in the short wave range (254 nm). This way the second partial image with the pattern containing information is visible only under short wave UV radiation. In the normal long wave UV range only the first partial image with the interference pattern in red fluorescent ink can be seen, which contributes to an increase in security.

The production of the item according to the invention is made using known methods. The proof against counterfeit is increased further in that the deposition of the partial images must take place on equipment that allows high precision positioning.

The item according to the invention may e.g. be any kind of packaging material in the form of packing material or packaging aid which features a transparent layer of material, whereby additional images according to the invention are deposited thereon. The packing material may be rigid, semi-rigid or flexible and may be a shaped body or a film-type material. Examples of shaped bodies are blown, deep-drawn and/or stretch-drawn shaped bodies such as bottles, wide-necked containers, beakers, dishes or base parts of push-through packs or blister packs. Examples of film-type materials are metal foils such as aluminium, steel, copper or gold foils. Further examples of film-type materials are papers such as tissue paper having a weight per unit area of 20-30 g/m² or highly whitened paper having a weight per unit area of 40-60 g/m², cardboard or semi-cardboard or the like. Important are in particular film-type materials containing plastic e.g. on the basis of polyolefines, such as poly-ethylenes or polypropylenes, polyamides, polyvinylchloride, polyesters, such as polyalkylene-terephthalates and in particular polyethytene-terephthalate. The plastic-containing films may be monofilms of plastics, laminates of two or more plastic films, laminates of metal foils and plastic films, laminates of paper and plastic films or laminates of paper and metal foils and plastic films. The individual plastic films may have a thickness e.g. of 12-200 μm and the metal foils a thickness of 12-100 μm. The individual layers of film-shaped materials may be joined to each other using adhesives, laminating adhesives, bonding agents and/or by extrusion coating, co-extrusion or laminating etc. Preferred plastic films are non-oriented or axial or biaxial oriented monofilms or laminates of two or more plastics on the basis of polyolefines, such as polyethylenes or polypropylenes, polyamides, polyvinylchloride, polyesters, such as polyakylene-terephthalates and in particular polyethylene-terephthalate.

The above mentioned packaging materials may form the item according to the invention as packing materials or packing aids. For example, by stamping and sealing the film-type packing materials it is possible to shape the said material into pouches, sachets, wraps etc. Films may be shape formed by deep-drawing and/or stretch-drawing into shaped forms of packaging or shaped bodies such as base parts for push-through packs or blister packs or wide-necked containers, menu-dishes, goblets, beakers etc. For example, tubes (laminate tubes) or lids for shaped forms of packaging may be manufactured from the films. Boxes such as collapsable boxes may e.g. be manufactured from substrates containing carton. It is also possible e.g. to employ bottles from blown plastic or pre-shaped forms of packaging and to apply the material layer according to the invention to them. Closures, seams, seams between a base part and a related lid etc., may be provided with a packaging aid according to the invention in the form of a label, sealing strip, revenue stamp, guarantee seal or covering. These last mentioned packing aids are normally in film form and are fixed to the appropriate part of the container over the opening and to the neighbouring part of the container, e.g. by adhesion, welding, flanging or shrinking etc. The packaging aid exhibits transparent layer of material according to the invention and the images kept apart by means of this. The structure of the surface or area of surface according to the invention leads to the intended optical effect on changing the angle of viewing. Counterfeiting by photocopying and using the photocopy as a guarantee of originality or guarantee of manufacturer would immediately be recognised as changing the angle of bviewing would not produce the optical effect which occurs with the structure according to the invention. In order that packing aids, e.g. sealing strips or revenue stamps, can be easily broken by the user, it may be useful to provide aids to tearing such as weaknesses, notches, or tear-off flaps. Also easy-to-tear or easy push-through films, such as plastic films containing filler materials or films made up of two plastic films that are not very compatible with each other may be used as a integral part of the packing materials or the packing aids.

Apart from the uses already mentioned for the item according to the invention in the form of packaging, packing material or a packing aid a further field of application is the counterfeit-proof manufacture of bonds, entry tickets and the like documents, whereby apart from the counterfeit-proof aspect it is also possible to produce special decorative effects.

1. Item bearing a printed image comprising at least one colored printing material that fluoresces under ultra-violet radiation of specific wavelength,
wherein,
the image is made up of two partial images, whereby a first partial image in a red fluorescent ink and the second partial image in a green or blue fluorescent ink are arranged as negative images with respect to each other in such a manner that to an observer simultaneously viewing both partial images, each eye individually through a color filter that is selected for each of the fluorescent colors of both partial images, the partial images appear as a three-dimensional image.

2. Item according to claim 1, wherein one of the two fluorescent printing inks is activated by ultra-violet radiation both in the long wave range (365 nm) and in the short wave range (254 nm) and the other fluorescent printing ink is activated only in the short wave range (254 nm).

3. Item with a image printed using at least one printing ink that is fluorescent under ultra-violet radiation of specific wave length,
wherein,
the image made up of a first partial image which is an essentially non-correlating interference pattern in a red fluorescent printing ink and a second partial image forming an essentially correlating pattern containing information which is printed with a green or blue fluorescent ink, whereby the pattern in the second partial image containing information is not recognizable for an observer viewing the partial images through a color filter selected for the red fluorescent printing ink.

4. Item according to claim 3, wherein the green or blue fluorescent printing ink of the second partial image with a pattern containing information is activated only in the short wave range (254 nm) and the red fluorescent printing ink of the first partial image with the interference pattern is activated both in the long wave range (365 nm) and in the short wave range (254 nm).

5. Use of an item according to claim 1 in the form of packaging, a packing material, a packing aid, a bond, an entry ticket or the like document with counterfeit-proof and/or optically demanding surface area.

6. Use of an item according to claim 2 in the form of packaging, a packing material, a packing aid, a bond, an entry ticket or the like document with counterfeit-proof and/or optically demanding surface area.

7. Use of an item according to claim 3 in the form of packaging, a packing material, a packing aid, a bond, an entry ticket or the like document with counterfeit-proof and/or optically demanding surface area.

8. Use of an item according to claim 4 in the form of packaging, a packing material, a packing aid, a bond, an entry ticket or the like document with counterfeit-proof and/or optically demanding surface area.
